(19) United States
(12) Patent Application Publication
(10) Pub. No.: US 2016/0196399 A1
(43) Pub. Date: Jul. 7, 2016

(54) SYSTEMS AND METHODS FOR INTERPRETIVE MEDICAL DATA MANAGEMENT

(71) Applicant: Chad E. Bonhomme, Indianapolis, IN (US)

(72) Inventor: Chad E. Bonhomme, Indianapolis, IN (US)

(21) Appl. No.: 14/912,008

(22) PCT Filed: Aug. 12, 2014
(86) PCT No.: PCT/US14/50750

§ 371 Date: Feb. 12, 2016

Related U.S. Application Data
(60) Provisional application No. 61/865,964, filed on Aug. 14, 2013.

(51) Int. Cl. G06F 19/00

(52) U.S. Cl. CPC G06F 19/345; G06F 19/322

(57) ABSTRACT

A data-driven interpretive medical data management system and method comprising a platform for storing and processing data, one or more devices in communication with the platform configured to collect data from a patient, and at least one user interface for displaying the data. Data received from the one or more devices is integrated into the appropriate databases of the platform and accessible by the appropriate users via the user interface. Further, the system interprets the data received from the one or more devices into actionable diagnostic data such that it may be easily and effectively used by a healthcare provider in treating the patient. The disclosed system and method may also serve as an early warning and/or diagnosis system through which the platform can automatically detect noteworthy events in the collected data on a near real time basis and alert the appropriate individuals.

### PRIORITY

The present international patent application is related to, and claims the priority benefit of, U.S. Provisional Patent Application Ser. No. 61/865,964, filed Aug. 14, 2013, the contents of which are hereby incorporated by reference in their entirety into the present disclosure.

### BACKGROUND

Hospital readmission statistics are a common standard used to judge the quality of care delivered at a particular facility. Examples of this include readmission for angina following discharge for percutaneous transluminal coronary angioplasty or admission for trauma following discharge for acute myocardial infarction. Currently, the government and other private payers are focused on controlling the costs associated with readmission, as they typically view unplanned hospital readmissions as wasteful spending and/or preventable. It is currently mandated by the Center for Medicare and Medicaid Services (CMS) that readmission rates are publicly reported and many payers (including CMS) institute financial penalties for poor performance and/or rewards for low readmissions. With the recent stimulus and paradigm shift towards accountable care, organizations are increasingly focused on cost reduction and implementing quality improvement efforts. While the majority of hospitals and related facilities employ readmission reduction programs, such programs typically focus on improving patient education, communication and home care and are of little effect. Accordingly, there is a large, growing need to help hospitals reduce preventable rate of readmissions to improve quality of care and avoid financial and legal implications, especially in the area of heart disease.

In recent years, advances in wireless communication, computing power and memory availability have translated into the medical device industry in terms of enabling the remote monitoring of patients. Accordingly, remote monitoring has emerged as an efficient and increasingly essential care delivery mechanism. As such, many implantable devices are now enabled for remote patient monitoring via device-based diagnostics and biometric capturing systems. Furthermore, it has been recognized that the efficient device-based management of physiological biometric data can provide a valuable means for assessing the risk of worsening physiological conditions and/or the likelihood of a patient's future hospitalization or readmission.

Despite this, remote monitoring remains underutilized by the medical community due, at least in part, to the general lack of infrastructure and available processes through which such data can be accessed, interpreted, and utilized in a meaningful and timely manner. For example, a conventional process for applying data collected by an implantable cardiac device entails downloading the collected data from the device only after the patient has presented with heart failure and been admitted to a hospital. At this point, the data collected by the device is of no value from a preemptive treatment perspective as the negative health event has already occurred. As such, the acquisition, transmission, work-flow and actionable responses of and upon device-based data remain lagging and cumbersome. In effect, while remote monitoring systems have potential and implantable devices are ripe with collected physiologic data, the collected device-based data remains unused or underutilized.

Currently, 5.7 million people in the United States alone have been diagnosed with heart failure, a disease that costs the United States over $34.4 billion each year and is the leading cause of hospitalization in people over 65 years of age. Indeed, atrial fibrillation (AFIB) alone impacts 2.5 million people in the United States and the incidence rate is expected to double over the next 40 years. The current estimate for annual Medicare spending for newly diagnosed AFIB patients is $15.7 billion. Furthermore, co-morbid conditions associated with AFIB act as a cost-multiplier as AFIB is associated with an increased risk of stroke, congestive heart failure (CHF), dementia, and death.

Implanted cardiac devices are commonly used in the treatments for a large portion of the aforementioned cases, with over 3 million cardiac devices implanted in the United States and over 300,000 new implants placed each year. Moreover, the prevalence of patients treated with implantable devices such as pacemakers and implantable cardioverter defibrillators has greatly increased in recent years, which has added some value in improving heart failure outcomes. However, the fact remains that while many of these implantable devices could or do include remote monitoring systems, the collected data remains unused and/or underutilized due to the lack of processes and systems capable of organizing and interpreting the vast amount of data into something useable by a patient and/or healthcare provider.

### BRIEF SUMMARY

In an exemplary embodiment an interpretive medical data management system of the present disclosure, the system comprises a platform having at least one storage server for storing data thereon and at least one computing server. The at least one computer server comprises at least one application capable of interacting with the data stored on the at least one storage server and may comprise various functionalities. The system further comprises at least one device in communication with the platform, wherein the at least one device is utilized in the treatment of a patient and collects patient data therefrom. Furthermore, the system additionally comprises at least one user interface in communication with the platform. The at least one user interface is for accessing and displaying the patient data stored on the least one storage server. In an exemplary embodiment, the at least one application analyzes and interprets the patient data collected from the patient from the at least one device to result in actionable diagnostic data in near real-time. Furthermore, at least one of the at least one applications analyzes the patient data collected from the patient from the at least one device on a continuous basis to detect a noteworthy event therein. Such noteworthy event may comprise a variation from statistical data, a data value, a data pattern or trend, a statistical estimation, or any other data point established and set by a user.

In an exemplary embodiment of a system of the present disclosure, at least one of the at least one application receives and aggregates the patient data collected from the patient from the at least one device on a continuous basis, and routes the aggregated data to the at least one storage server for storage thereon. In another embodiment, the at least one application receives, aggregates and stores the patient data on a near real-time basis. In yet another embodiment, at least one of the at least one application interprets the patient data collected from the patient from the at least one device into actionable, diagnostic information.

In an exemplary embodiment of a system of the present disclosure, at least one of the at least one application analyzes the patient data collected from the patient from the at least one device to detect a noteworthy event therein. In an additional embodiment, a noteworthy event comprises a variation from statistical data, a data value, a data pattern or trend, or a statistical estimation. In yet an additional embodiment, the at least one application applies diagnostic or predictive algorithms to detect the noteworthy event.

In an exemplary embodiment of a system of the present disclosure, the user interface comprises a web-based portal. In another embodiment, user interface further comprising a mobile application configured to access the web-based portal. In yet another embodiment, the user interface is configured to receive input from a user. In various embodiments, the at least one device comprises a pacemaker, an implantable cardioverter defibrillator, and/or an implant for cardiac resynchronization therapy.

In an exemplary embodiment of a system of the present disclosure, the patient data comprises data selected from the group consisting of hemodynamic data, thoracic fluid content data, heart rate variation data, biometric data, physiologic data, temperature data, respiratory rate data, oxygen saturation data, weight data, intrathoracic impedance data, heart rhythm data, electrocardiography data, heart rate data, mean heart rate data, average heart rate data, QT interval data, ST segment data, premature ventricular contraction data, blood glucose concentration data, and cardiac resynchronization therapy pacing percentage data. In various embodiments, the at least one device is in wired or wireless communication with the platform. Wireless communication may include, but is not limited to, infrared communication and/or cellular communication. In an additional embodiment, the patient data is stored within a patient information database within the at least one storage server. In yet an additional embodiment, the patient data comprises personally identifiable information. In another embodiment, the actionable diagnostic data is stored within a second database within the at least one storage server.

In an exemplary embodiment of a system of the present disclosure, the patient data comprises personally identifiable data and de-identified data. In another embodiment, the personally identifiable data is stored in a first database in the at least one storage server, and wherein the de-identified data is stored in a second database in the at least one storage server. In yet another embodiment, the first database has first access rights and the second database has second access rights, wherein the first access rights are different from the second access rights.

In an exemplary embodiment of a system of the present disclosure, the system further comprises at least one reference database in communication with the platform. In an additional embodiment, the at least one reference database is stored on the at least one storage server. In yet an additional embodiment, the at least one reference database is stored outside of the at least one storage server. In another embodiment, the at least one reference database comprises statistical data stored thereon. In yet another embodiment, the at least one application associates the patient data with the statistical data to result in the actionable diagnostic data.

In an exemplary embodiment of a system of the present disclosure, at least one of the at least one application comprises a detection application configured to generate an alert regarding a potential clinical event. In another embodiment, the alert is transmitted to at least one of the patient and a health care provider of the patient. In yet another embodiment, the alert is generated based upon the actionable diagnostic data, wherein the actionable diagnostic data identifies a symptom related to a condition of the patient. In an additional embodiment, the alert is generated based upon the actionable diagnostic data, wherein the actionable diagnostic data identifies a noteworthy event related to a condition of the patient.

In an exemplary embodiment of a system of the present disclosure, the device comprises a pacemaker, and the noteworthy event comprises a heart rhythm irregularity. In an additional embodiment, the device comprises an intrathoracic impedance monitor, and wherein the noteworthy event comprises an impedance measurement below a specified value. In yet an additional embodiment, wherein the noteworthy event comprises an event occurring outside of a set of guidelines established for the patient.

In an exemplary embodiment of a system of the present disclosure, the system is operable to monitor a patient who has experienced a heart condition. In another embodiment, the heart condition comprises congestive heart failure. In yet another embodiment, the patient data is selected from the group consisting of intrathoracic impedance data, patient activity data, heart rate variability data, atrial arrhythmia burden data, ventricular heart rate during atrial arrhythmia data, premature ventricular contraction data, average heart rate data, and cardiac resynchronization therapy pacing percentage data. In an additional embodiment, the actionable diagnostic data indicates an improving or worsening trend of the patient data over time. In yet an additional embodiment, at least one of the at least one application is configured to generate an alert based upon the actionable diagnostic data that indicates the worsening trend. In another embodiment, the worsening trend is indicative of a condition selected from the group consisting of a new onset of atrial flutter or fibrillation, ventricular tachy-arrhythmias, anti-tachycardia pacing episodes, shock delivery episodes, system hardware failure, device hardware failure, system software failure, device software failure, battery depletion, and missed remote interrogations. In yet another embodiment, the patient data is compared to statistical data from at least one reference database within the system or in communication with the system to generate the actionable diagnostic data.

In an exemplary embodiment of a system of the present disclosure, the heart condition comprises an arrhythmia. In an additional embodiment, the patient data is selected from the group consisting of patient activity data, atrial arrhythmia burden data, heart rate variability data, ventricular heart rate during atrial arrhythmia data, average heart rate data, and cardiac resynchronization therapy pacing percentage data. In yet an additional embodiment, the actionable diagnostic data indicates an improving or worsening trend of the patient data over time. In another embodiment, at least one of the at least one application is configured to generate an alert based upon the actionable diagnostic data that indicates the worsening trend. In yet another embodiment, the worsening trend is indicative of a condition selected from the group consisting of a new onset of sustained rapid ventricular response, system hardware failure, device hardware failure, system software failure, device software failure, battery depletion, and missed remote interrogations. In an additional embodiment, the patient data is compared to statistical data from at least one reference database within the system or in communication with the system to generate the actionable diagnostic data.

In an exemplary embodiment of a system of the present disclosure, the alert is generated prior to the patient being aware of a symptom related to a condition of the patient being monitored by the system. In various embodiments, the at least one storage server is in communication with a processor configured to access and store the patient data. In various embodiments, the at least one storage server comprises a storage medium. In various other embodiments, the at least one storage server comprises processor configured to access and store the patient data on at least one storage medium. In various embodiments, the at least one computing server is in communication with a processor configured to analyze and interpret the patient data using the at least one application. In various embodiments, the at least one computing server comprises a storage medium. In various other embodiments, the at least one computing server comprises processor configured to analyze and interpret the patient data stored on at least one storage medium using the at least one application.

In an exemplary embodiment of a method for interpreting and managing device-based data of the present disclosure, the method comprises the steps of establishing a communication link with at least one device collecting data from a patient, receiving data from the at least one device and routing the data to at least one storage server for storage thereon, running an application on a server to interpret the data into actionable, diagnostic information, and displaying the actionable, diagnostic information to a user through a user interface. The method may also comprise the step of analyzing the actionable, diagnostic information on a continuous basis to detect a noteworthy event therein, detecting a noteworthy event, and alerting one or more users as to the occurrence of the noteworthy event on a near real-time basis.

In an exemplary embodiment of a method for interpreting and managing device-based data of the present disclosure, the step of alerting further comprises displaying the actionable, diagnostic information relevant to the noteworthy event on the user interface. Various steps, such as the receiving and running steps, can be performed on a continuous basis. Methods of the present disclosure may further comprise the step of aggregating the received data. The receiving step noted above may further comprise routing the data to a patient-specific file on a continuous. Devices used in connection with various methods of the present disclosure can be implantable medical devices. Various steps, such as the analyzing step noted above, can be performed on a continuous basis. Various methods can further comprise one or both of the steps of accessing the user interface through a mobile application, wherein the user interface comprises a secure web-based portal, and/or the step of calling up the patient-specific file from the user interface for display, wherein the patient-specific file is dynamic such that the display of the file is automatically updated with actionable, diagnostic information on a near real-time basis.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIG. 1 shows a schematic/block diagram of an interpretive system for medical data management, according to an exemplary embodiment of the present disclosure; and

FIG. 2 shows a flow diagram of a method for providing an interpretive medical data management service according to an exemplary embodiment of the present disclosure.

An overview of the features, functions and/or configurations of the components depicted in the various figures will now be presented. It should be appreciated that not all of the features of the components of the figures are necessarily described. Some of these non-discussed features, such as various couplers, etc., as well as discussed features are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

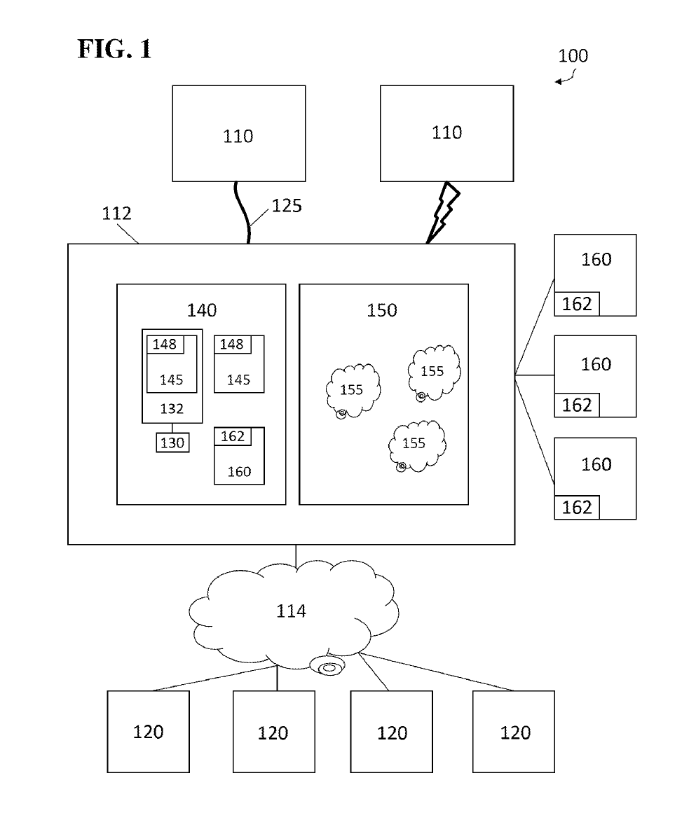

An exemplary system for interpretive medical data management of the present disclosure is shown in FIG. 1. As shown in FIG. 1, the interpretive medical data management system 100 comprises one or more medical devices 110 in communication with a platform 112, where the components of the platform 112 (and any data stored thereon) are accessible by one or more users 120 via a user interface 114. These and other components are described in further detail below.

At least in part, the interpretive medical data management system 100 comprises an interpretive data service that is capable of receiving data 148 from the one or more medical devices 110 and translating such data 148 into informative and actionable information that is easily usable by patients, caregivers and other parties. In at least one embodiment, the system 100 also provides early warnings in the event worsening physiological conditions are detected (i.e. the data 148 collected falls outside of established parameters). Furthermore, the interpretive medical data management system 100 enables users 120 to immediately access device-based data 148 on a near real time basis (e.g., within seconds to several minutes). In this manner, a user 120 can detect an increased likelihood of costly, clinically important events occurring and preemptively act on such information to avoid an adverse health event in the patient. Accordingly, an exemplary interpretive medical data management system 100 of the present disclosure enhances disease diagnosis and management, and may be used to improve quality of care, decrease readmission rates, and decrease overall healthcare costs.

As shown in FIG. 1, the interpretive medical data management system 100 comprises one or more medical devices 110 in communication with the platform 112. The one or more medical devices 110 may comprise any medical device(s) known in the art configured to collect data 148 from a patient. Further, in at least one embodiment, an exemplary medical device 110 of the present disclosure may be configured to format and/or transmit the device-based data 148 collected from the patient to the platform 112. As used herein, the term “device-based data” means and includes some or all data 148 collected from a patient by a medical device 110.

In at least one embodiment, a medical device 110 is implantable. For example and without limitation, an implantable medical device 110 may comprise a pacemaker, implantable cardioverter defibrillator or implantable loop record. Alternatively, a medical device 110 may be removably attached to patient or configured to remotely gather information therefrom. Furthermore, a medical device 110 may comprise one or more external body sensors or portable imaging modalities. It will be appreciated that the one or more medical devices 110 of the system 100 may all comprise the same type of device or any variety of different devices, depending on the specific application of the system and/or each individual patient's needs.

The device-based data 148 collected by each of the one or more medical devices 110 may comprise biometric data, physiologic data, demographic information, diagnostic information, and/or any other data collected by the medical device 110 from or regarding a patient. This device-based data 148 may be collected from the patient internally, as in the case of an implantable medical device, or externally, such as with vital sign data such as temperature, respiratory rate, oxygen saturation, and/or weight. In an exemplary embodiment, the device-based data 148 comprises intrathoracic impedance data collected by an implantable medical device 110. In at least one additional embodiment, the device-based data 148 collected by the medical device 110 comprises heart rhythm data and/or electrocardiography (ECG) data. Further examples of device-based data 148 include, but are not limited to, patient activity, heart rate, mean heart rate, average heart rate, QT interval data, ST segment data, premature ventricular contractions per hour, glucose concentration in the blood, and cardiac resynchronization therapy pacing percentages.

The one or more medical devices 110 may be connected to, or in communication with, the platform 112 via a wired connection and/or wirelessly. Accordingly, an exemplary interpretive medical data management system 100 of the present disclosure may collect data 148 on both inpatient and remote bases. Where a wired connection is employed, the one or more medical devices 110 may be connected to the platform 112 through cabling, such as one or more wires 125, shown in FIG. 1. Additionally and/or alternatively, the one or more medical devices 110 may communicate with the platform 112 (or components thereof) through infrared transmission, wireless transmission (such as identified by the jagged line shown in FIG. 1), telemetry, cellular transmission, and/or any other appropriate wireless means. Where a medical device 110 comprises a wireless connection, the patient from which the medical device 110 gathers device-based data 148 may be located anywhere, including in a treatment suite or remotely.

It will be appreciated that where the system 100 comprises a plurality of medical devices 110, such devices 110 need not all be in communication with the platform 112 via the same wired or wireless configuration. As such, the system 100 may comprise some devices 110 configured to communicate with the platform 112 wirelessly, while other devices 110 are connected to the platform 112 via a wired connection. Furthermore, where application of the interpretive medical data management system 100 entails the collection and/or transmission of device-based data 148 that includes confidential and/or personally-identifiable information, the medical devices 110 and/or the wired/wireless connections may include the appropriate safeguards to ensure that the collection and transmission of such device-based data 148 is secure. Additionally, one or more medical devices 110 may be configured to simultaneously direct the collected data 148 to two or more separate servers—for example, the platform 112 and one or more external servers. These external servers may comprise any third-party servers and, in at least one embodiment, may comprise a server hosted by or on behalf of the company who manufactured the device 110. In this manner, the device manufacturer can maintain surveillance over system failures of its medical devices 110.

In addition to the aforementioned, third-party systems may also collect device-based data 148 from medical devices 110 and transmit that device-based data 148 to the platform 112. For example and without limitation, the system 100 may interact with ScottCare Cardiovascular Solutions or the like to obtain device-based data 148. For the sake of clarity, the term “medical device 110” as used herein will mean and include the devices previously described and also any third-party systems or servers from which device-based data 148 may be obtained by the interpretive medical data management system 100.

As previously described, the one or more medical devices 110 of the system 100 are in communication with the platform 112. In general, the platform 112 supports cross-connectivity among patients, healthcare providers, payers and the medical device manufacturer industry (each an exemplary “user” 120 of the system 100). Indeed, the platform 112 is the component of the system 100 where the device-based data 148 collected by the medical devices 110 is accumulated, interpreted and made available to users 120 (either on a near real time or delayed basis) in an easily useable format.

The platform 112 is capable of multiple functionalities that may be customized according to a particular application of the system 100. As described in more detail below, the platform 112 may be configured to perform initial transformation and aggregation processes (as necessary) on raw device-based data 148 received from a medical device 110 to ensure the device-based data 148 is readable by the platform 112, analyze the formatted device-based data 148, translate and interpret the analyzed device-based data 148 into informative and actionable information, and store such processed device-based data 148 so that it is easily accessible by a user 120. Furthermore, as described in more detail below, the platform 112 may additionally serve as an alerting system. In this embodiment, the platform 112 is further configured to automatically alert one or more users 120 to potentially life threatening events as identified by specific device-based data 148 falling outside of certain established parameters.

The platform 112 comprises at least one storage server 140 for storing device-based data 148 and at least one computing server 150 for running one or more applications or services. The storage server 140 and the computing server 150 may consist of a single server or multiple linked servers, which may be used together or singly. The storage server 140 comprises one or more databases 145 in which the device-based data 148 is stored.

It will be understood that the storage server 140 may comprise any number of databases 145. Furthermore, each of the one or more databases 145 may be designated to store particular types and/or formats of device-based data 148 and/or configured to require specific user 120 authorization credentials such that the database is only accessible to certain users 120. For example, in an exemplary embodiment, the storage server 140 comprises a patient information database 145 and a de-identified, aggregate information database 145. In this embodiment, the patient information database 145 stores device-based data 148 collected from one or more patients, including confidential, personally identifiable information. Further, the patient information database 145 may be configured such that only a user 120 who is an authorized healthcare professional or the applicable patient can gain access. Alternatively, in this embodiment, the de-identified, aggregate information database 145 is designated to store only de-identified device-based data 148 in the aggregate and is configured such that only approved users 120 can gain access (for example, and without limitation, a user 120 who is a member of the device manufacturing industry, a researcher, or an individual who has paid a subscription fee to access the service). Accordingly, the one or more databases 145 of the storage server 140 may be customized according to the application of the system 100 and/or users' 120 specific needs.

In addition to the storage server 140, the platform 112 further comprises the computing server 150. The computing server 150 comprises one or more applications 155 (software, for example) running on the platform 112. The applications 155 interact with the one or more medical devices 110 and/or the database(s) 145 of the storage server 140 to acquire, process, and interpret the collected device-based data 148 into actionable data 148. Thereafter, the applications 155 are operable to store such interpreted device-based data 148 in one or more databases 145 of the storage server 140 such that it may be accessed and/or utilized by a user 120. Storage server 140 and computing server 150, as referenced herein, may contain any number of components known in the art that form components of traditional computers, such as one or more processors 130, one or more storage mediums 132 (such as one or more hard drives, discs accessible using optical disc drives, flash memory drives (chip and/or USB, for example), and/or other storage mediums known in the art), memory, and the like. For example, when referring to “at least one storage server for storing data thereon,” the present disclosure refers to at least one storage server 140 at least configured to store data 148, such as by operating a processor 130 to store data 148 in a storage medium 132. FIG. 1 depicts a storage server 140 comprising a processor 130 in communication with a storage medium 132, whereby database 145 and data 148 are contained within storage medium 132. Applications 155, such as shown in FIG. 1, can be stored within computing server 150, wherein computing server comprises or includes one or more storage mediums 132, whereby operation of a processor 130 can cause applications to operate as desired.

As previously noted, the one or more applications 155 of the computing server 150 can perform various functionalities. It will be appreciated that any number of applications 155 may be included in the computing server 150, and that the functionality of such applications 155 may be customized depending upon the application of the interpretive medical data management system 100 and/or pursuant to user 120 preference. In at least one embodiment, the computing server 150 includes one or more applications 155 for transforming the raw device-based data 148 received from the medical device(s) 110 into a readable format and/or aggregating such formatted data 148 into patient-specific files for storage in a database 145. Other applications 155 may direct patient-specific files for storage as part of the relevant patient's records in a database 145 such that the data 148 is easily accessible by an authorized healthcare professional and/or the patient. Along those same lines, the computing server 150 may comprise applications 155 for copying certain device-based data 148, stripping the personally identifiable information therefrom, and routing the de-identified data 148 for storage in a separate database 145. Accordingly, it will be appreciated that the applications 155 can be used to identify various types of device-based data 148, format and/or aggregate the same pursuant to a pre-programmed logic, and route the processed device-based data 148 into the appropriate database 145 for user 120 access and storage. Furthermore, depending on how often the relevant application 155 and/or the medical device(s) 110 are set to upload the device-based data 148 to the platform 112, the device-based data 148 may be processed, interpreted and stored in near real time such that it can be made available to users 120 (either on a near real time or delayed basis) in an easily useable format.

While it is useful for the device-based data 148 to be allocated and stored in assigned databases 145 to facilitate user 120 access thereto, without further processing the collection of device-based data 148 is not easily decipherable and, often times, the vast amount of data 148 collected prevents its utilization. Accordingly, the computing server 150 may further comprise one or more applications 155 for analyzing and/or interpreting the device-based data 148 into informative and actionable information. Specifically, an analysis application 155 analyzes the collected device-based data 148 either through meta-analysis, population analysis, individual-based analysis, or any other analysis known in the art, depending on the desired result. In at least one embodiment, the analysis application 155 performs a meta-analysis of the received device-based data 148 to identify patterns, discrepancies, and/or other noteworthy relationships therein. Further, an interpretation application 155 interprets a patient's device-based data 148 collected from one or more medical device(s) 110 into a format easily useable for diagnostic purposes. Accordingly, such analysis and interpretation applications 155 enable the interpretive medical data management system 100 to obtain raw device-based data 148 and display it in binary, graphical or alerting formats against, for example, a statistical standard or a learned patient baseline. In this manner, the device-based data 148 may be easily interpreted by users 120 such that they can proactively use the interpreted data 148 to make timely, well-informed decisions.

In an exemplary embodiment, the interpretation application 155 interacts with the designated database(s) 145 to automatically analyze and interpret a patient's device-based data 148 on a near real time basis. This may include applying diagnostic or predictive algorithms, and/or invoking a trend analysis, statistical analysis or pattern recognition applications. In at least one embodiment, the interpretation application 155 may interact with, and pull statistical data 162 from, reference databases 160. Reference databases 160 (which can include search engines) may comprise databases of best demonstrated practices and industry guidelines that are maintained by medical societies and research institutions. In addition, reference databases 160 may also include databases maintained by private insurance companies and public government sponsored healthcare payment agencies (to provide medical claims data relating to the individual patient) and/or databases maintained by device manufacturing companies (to provide equipment trouble shooting information). As shown in FIG. 1, these reference databases 160 may be integrated within the platform 112 itself, or independent thereof and accessible via the Internet or other communication means.

The statistical data 162 pulled from the one or more reference databases 160 may be accessed and used in connection with the analysis and interpretation of the patient's device-based data 148. For example, the interpretation application 155 may access and mine the statistical data 162, and thereafter associate pertinent statistical data 162 with the patient's device-based data 148 to form a specific medical profile or diagnosis.

Furthermore, as described in more detail below, the computing server 150 may additionally comprise a detection application 155 for automatically alerting a patient and his or her healthcare provider(s) of an increase in the probability that a clinical event will occur. Often times, there are physiological signs of an approaching clinical event days or even weeks prior to the onset of clinical systems. While such symptoms conventionally go unnoticed until resulting in a life threatening event, the interpretive medical data management system 100 can detect the first indication that a negative health event may occur and bring this information to the patient's and/or healthcare provider(s) attention (sometimes even prior to the onset of clinical symptoms). This functionality not only provides a quick and effective process through which device-based data 148 may be utilized, it also eliminates the need for a technician or other healthcare professional to be stationed at or near the patient or a user interface to monitor patient output. As such, the system 100 increases the patient's quality of life, while reducing costs and promoting the delivery of an exemplary quality of care.

In an exemplary embodiment, the detection application 155 is an event-driven mechanism that anticipates the occurrence of a negative health event by detecting significant variations from the norm and/or predicting future clinical trends based on continuous data analysis. This may include applying diagnostic or predictive algorithms, or simply searching a patient's device-based data 148 on a continuous basis for one or more noteworthy events defined by a user 120 (most likely a physician or other healthcare provider). A noteworthy event may comprise any data value, data pattern or trend, statistical estimation, and/or event indicated by a user 120 (whether a patient, healthcare provider, or other type of user 120). For example, in at least one embodiment where one of the medical devices 110 is a pacemaker, the noteworthy event may be a data trend such as an increase or irregularity in a heart rhythm. Alternatively, where a medical device 110 comprises an intrathoracic impedance monitor, the noteworthy event may be a data point falling outside of certain established parameters (e.g., an intrathoracic impedance measurement falling below a specified value). Still further, a noteworthy event may be a deviation from a learned patient baseline, a value set pursuant to patient preference, or a deviation from a defined manufacturer parameter such that a device manufacturer and/or other user 120 can monitor the functionality and/or accuracy of a medical device 110. Additionally, a noteworthy event may be set according to standard of care guidelines, which can either be manually defined or the detection application 155 can be programmed to mine one or more reference databases 160 to establish the same. Noteworthy events are fully customizable and any number of noteworthy events may be indicated for detection by the detection application 155.

Referring back to FIG. 1, one or more users 120 may access particular data 148 stored within the platform 112 via a user interface 114 and a communication link (not shown). In at least one embodiment, the user interface 114 may comprise a web-based (Internet or other network, for example) portal that provides functionality for accessing and displaying data 148 stored within the storage server 140 of the platform 112. In an exemplary embodiment, the user interface 114 comprises a mobile application and/or widget designed to run on smartphones, tablet computers and other mobile devices for accessing the web-based portal. Notwithstanding the aforementioned, it will be noted that the user interface 114 may comprise any application through which a user 120 can access the platform 112 and communicate therewith, and shall be operable as intended through any number of different networks. It is noted that exemplary systems 100 of the present disclosure contain elements, such as devices 100, platforms 112, components of platforms 112 (such as servers 140, 150 and components therein), reference databases 160, and users 120, that can interact/interface with other said elements, such as a user 120 interacting/interfacing with user interface 114 and platform 112, devices 120 interfacing with platform 112, etc., through any number if means, including wired, wireless, and/or networked means, including the Internet and other types of networks.

The user interface 114 may have a CRT display, an LCD display, a printer, a speaker, or any other type of display or output device known in the art. Furthermore, the user interface 114 may also comprise at least one input device, such as a keyboard. The display and associated content of the user interface 114 is fully customizable. For example, the display and content of the user interface 114 may be customized for particular classes of users 120 such that the system 100 can provide standardized user interfaces 114 having features and functionality specifically tailored to its users' 120 needs. In at least one embodiment, where a user 120 is a healthcare provider, the display and content of a user interface 114 may provide high-level medical content and links to medical desk references, and comprise graphics, information, and/or functionality tailored to a physician's needs. Likewise, where the user 120 is a patient, the display and content of the user interface 114 may be more general, provide links to informative websites and/or other resources, and comprise graphics, information and functionality geared towards a patient's level of understanding and needs.

The display of the user interface 114 may also be customized with respect to particular health conditions. Examples 1 and 2 describe embodiments of such condition-specific content for use with an interface display 114 (an exemplary user interface). Specifically, Example 1 is directed towards a non-limiting example of content for use with a congestive heart failure user interface 114, and Example 2 illustrates a non-limiting example of content for use with an arrhythmia user interface 114. It will be appreciated that the display and content of a user interface 114 may be tailored to any physiological condition and/or disease in accordance with a user's 120 needs.

### Example 1

### CHF User-Interface

An exemplary mApp user interface for CHF of the present disclosure can have some or all of the following characteristics and/or operate to obtain, use, and/or process the following:
1. Internal Physiological Biometric Data including:
   a. Intra-Thoracic Impedance
   b. Patient Activity
   c. Heart Rate Variability
   d. Atrial Arrhythmia Burden
   e. Ventricular Heart Rate during Atrial Arrhythmia
      i. Mean Heart Rate
      ii. Heart Rate Histogram
   f. Premature ventricular contractions (PVCs) per hour
   g. Average Heart Rate
   h. Cardiac Resynchronization Therapy (CRT) pacing percentage
2. Simple trending translation of the above data (Improving vs. Worsening)
3. Raw data link to download the entirety of device checks (Interrogations)
4. Early Warning short message service (SMS) for Red Alert Biometric Parameters such as:
   a. New onset atrial flutter or fibrillation
   b. Ventricular Tachy-arrhythmias
   c. Anti-tachycardia pacing (ATP) episodes
   d. Shock Delivery episodes
   e. Hardware or software system failures
   f. Battery Depletion
   g. Missed Remote Interrogations
5. Up to Date information on Pacemakers/AICDs via iPacemaker app currently available in iOS (will need to be available in Android).
6. Freemium newsfeed on Device related, Heart Failure related, Arrhythmia related, and Telemedicine related issues.
7. Freemium data and newsfeed on HT internal research such as:
   a. Comparable device performance: Population to Own Device
      i. Battery Longevity
      ii. Atrial Pacing
      iii. Ventricular Pacing
      iv. BiVentricular Pacing
      v. Arrhythmia Burden
      vi. Device Comfort Score
   b. Comparable device clinic assessments
   c. Comparable mobile Health on-call Provider responsiveness

### Example 2

### Arrhythmia User-Interface

An exemplary mApp user interface for Arrhythmia of the present disclosure can have some or all of the following characteristics and/or operate to obtain, use, and/or process the following:
1. Internal Physiological Biometric Data including:
   a. Patient Activity
   b. Atrial Arrhythmia Burden
   c. Heart Rate Variability
   d. Ventricular Heart Rate during Atrial Arrhythmia
      i. Mean Heart Rate
      ii. Heart Rate Histogram
   e. Average Heart Rate
   f. PVCs per Hour
2. Simple trending translation of the above data (Improving vs. Worsening)
3. Raw data link to download the entirety of device checks (Interrogations)
4. Early Warning SMS for Red Alert Biometric Parameters such as:
   i. Sustained Rapid Ventricular Response
   ii. Ventricular Tachy-arrhythmias
   iii. Battery Depletion
   iv. Hardware or software system failures
   v. Missed Remote Interrogations
5. Up to Date information on Pacemakers/AICDs via iPacemaker app currently available in iOS (will need to be available in Android).
6. Freemium newsfeed on Device related, Heart Failure related, Arrhythmia related, and Telemedicine related issues.
7. Freemium data and newsfeed on HT internal research such as:
   d. Comparable device performance: Population to Own Device
      i. Battery Longevity
      ii. Atrial Pacing
      iii. Ventricular Pacing
      iv. BiVentricular Pacing
      v. Arrhythmia Burden
      vi. Device Comfort Score
   e. Comparable device clinic assessments
   f. Comparable mobile Health on-call Provider responsiveness

An exemplary user interface 114 may further be configured to receive user 120 input. In an exemplary embodiment, the user interface 114 is configured to request that a user 120 enter a password and/or other form of identification when accessing the system 100. In this manner, the user interface 114 can provide a layer of security to the interpretive medical data management system 100 and ensure only authorized users 120 gain access to the sensitive and confidential information stored thereon. Furthermore, the interpretive medical data management system 100 can also employ user-level access controls for security purposes as is commonly known in the art. Accordingly, in at least one embodiment, each user 120 may be assigned particular credentials to provide him or her with access to data 148 stored in particular records and/or databases 145. For example, a patient may be restricted to only accessing his or her patient files stored on the storage server 140. Likewise, a device manufacturer or researcher may be assigned credentials that restrict his or her access to only those records and/or databases 145 containing de-identified, aggregate data 148. Furthermore, a healthcare provider could have broader access such that he or she can call up any of his or her patients' stored medical records for review. Through the use of such credentials and access control lists, the system 100 can support numerous users 120 concurrently accessing designated records and/or databases 145 stored on platform 112, while maintaining and safeguarding the security and confidentiality of the data 148 stored thereon.

A user 120 may also utilize the user interface 114 to communicate across the platform 112 with patients, payers, healthcare providers and device manufacturers and developers. For example, in at least one embodiment, a user 120 may submit service feedback, suggestion box submissions, responses to questionnaires, and/or other general information or inquiries to the user interface 114 for delivery to the appropriate party. More specifically, in at least one embodiment, such a user interface 114 facilitates consumer-payer communication through payer-driven inquiries on quality, satisfaction, responsiveness, ease of use, assessments of clinical variance or providers, and/or a patient's perspective regarding the performance of a medical device 110. User 120 input may be submitted and/or transmitted in the form of an e-mail, instant message or any other form of transmission that is known in the art. Furthermore, in at least one embodiment, the user interface 114 is also configured to enable a user 120 to access a virtual or live resource, such as a mobile on-call healthcare provider, via an Instant Messaging service.

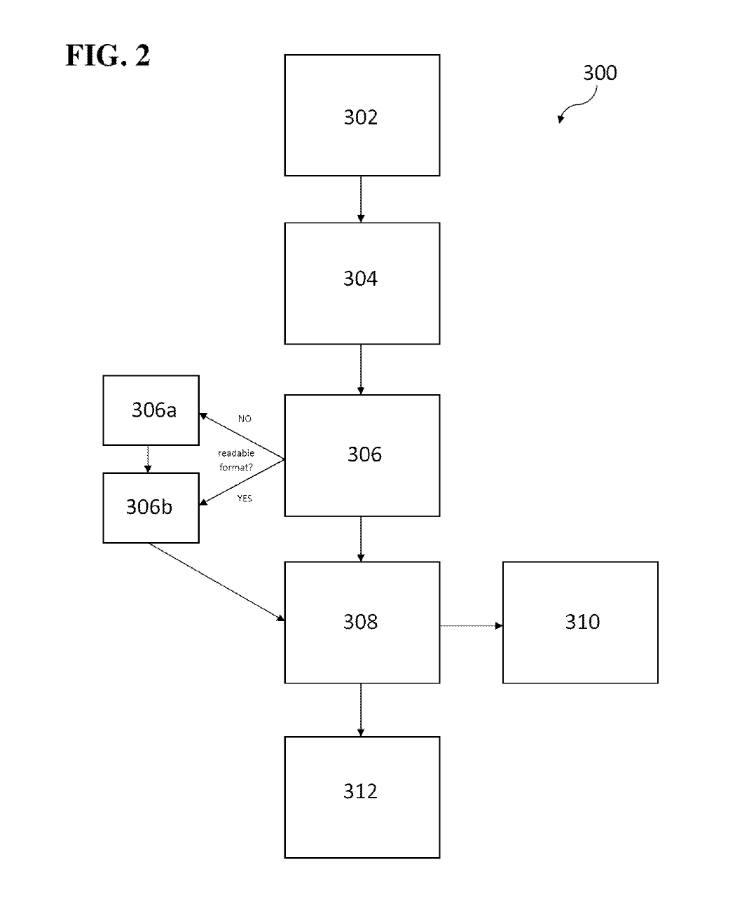

Now referring to FIG. 2, flow charts of a method 300 for providing an interpretive medical data management service are shown. While the method 300 is described herein in connection with a patient being treated for congestive heart failure (CHF), it will be understood that the method 300 may be used to provide interpretive data management services for any health issue, disease or condition that could benefit from internally and/or externally captured device-based data 148, such as diabetes, hypertension, kidney disease, asthma, coagulation regulation, QT interval monitoring of anti-arrhythmic medications, and ST segment monitoring, for example. Accordingly, method 300, and the embodiments thereof, can be applied to a vast range of conditions to revolutionize conventional preventive care standards through the quick and effective reporting of current and actionable device-based data 148. Furthermore, it will be understood that the steps of method 300 may be run on a continuous basis, such that near real-time, device-based data 148 is available to and accessible by a user 120.

As shown in FIG. 2, in one approach to the method 300, at step 302 at least one medical device 110 is activated such that it obtains device-based data 148 from a patient as is known in the art. For example and without limitation, where the patient is being monitored in connection with CHF, the medical device 110 may comprise a pacemaker, an implantable cardioverter defibrillator, an implant for cardiac resynchronization therapy, or a similar implantable device capable of collecting data 148 related to such condition (e.g., hemodynamics, thoracic fluid content, heart rate variation, etc.). At step 302, such implantable device 110 is implanted and activated such that data 148 collection begins. Additionally or alternatively, where at least one of the medical devices 110 comprises a portable imaging modality, at step 302 the image is created. At step 304, the device-based data 148 collected by the medical device 110 is transmitted to the platform 112 through device interrogation or as is otherwise known in the art. Such device interrogation may be initiated by either the medical device 110 or run by the computing server 150 of the platform 112. In one embodiment, one or more applications 155 of the platform 112 continuously upload the device-based data 148 from the medical device(s) 110 to the platform 112, or do so on an interval basis. Additionally or alternatively, the device-based data 148 may be pushed to the platform 112 by the medical device 110 itself. It will be appreciated that any combination of the aforementioned may be employed, depending on the configuration(s) of the medical device(s) 110 involved and the specific applications 155 utilized. Furthermore, if desired, in addition to transmitting the data 148 to the platform 112, the device-based data 148 may also be simultaneously transmitted to one or more external servers at step 304.

After the device-based data 148 is uploaded to the platform 112, the computing server 150 processes the device-based data 148 at step 306. Such processing step 306 may include transforming the device-based data 148 into a readable format at sub-step 306a and/or aggregating such data 148 as desired at sub-step 306b. Specifically, upon receipt of the device-based data 148 from the medical device 110 at step 304, it is determined whether or not such data 148 is in a readable format. Where the device-based data 148 received by the platform 112 is raw (i.e. not in a format readable by the platform 112), step 306 includes sub-step 306a and the computing server 150 utilizes one or more applications 155 commonly known in the art to transform the raw device-based data 148 into a format readable by the platform 112. Alternatively, if the device-based data 148 is in a readable format upon receipt from the medical device 110, step 306 of the method 300 skips sub-step 306a and proceeds directly to sub-step 306b.

At sub-step 306b, one or more of the applications 155 of the computing server 150 aggregate the device-based data 148 pursuant to a set of pre-programmed rules. For example, where a patient is being monitored in connection with CHF, the computing server 150 may run an aggregation application 155 to aggregate the received device-based data 148 into files for storage in the database 145 with that patient's records. In this manner, the data 148 is stored such that it is easily accessible by an authorized healthcare professional and/or the patient. It may also be desirable to additionally store the CHF-related data 148 in a first general database 145 for research purposes and/or to store data 148 specific to the medical device 110 in a second general database 145. In such cases, at processing step 306b, the computing server 150 may run one or more additional applications 155 to copy, process, aggregate and store the specified device-based data 148 as appropriate.

For example and without limitation, at step 306b the computing server 150 may run an application 155 to strip the personally identifiable information from the device-based data 148, copy the de-identified data 148 as necessary, and route the CHF-related, de-identified data 148 for storage to a research database 145 and the device-related, de-identified data 148 for storage to a device manufacturer database 145. In this manner, the platform 112 can provide one or more databases 145 comprising HIPAA-compliant data 148 that is relevant to particular subject matter. This may be particularly useful to certain classes of users 120 (such as researchers, insurers, medical device manufacturers, etc.) who may be able to pull valuable information and trends from such de-identified data 148 in the aggregate, but are not otherwise able to access the same due to confidentiality concerns.

While it is useful for the device-based data 148 to be allocated and stored in assigned databases 145 to facilitate user 120 access thereto, without further processing, the collection of device-based data 148 is not easily usable. Accordingly, at step 308, the interpretive medical data management system 100 analyzes and/or interprets the device-based data 148 into easily decipherable and actionable information.

At step 308, the computing server 150 runs one or more analysis and/or interpretation applications 155 to automatically analyze and interpret the stored device-based data 148. As previously described, such analysis applications 155 may include meta-analysis, population analysis, and/or individual-based analysis, and such interpretive applications 155 may include the application of diagnostic or predictive algorithms, invoking trend analysis, statistical analysis or pattern recognition applications, and/or the interpretive applications 155 interacting with one or more reference databases 160. In the exemplary embodiment of a patient being monitored for CHF, the analysis application 155 analyzes the device-based data 148 stored in the patient's records (either individually or in conjunction with a larger data set) and the interpretative application 155 interprets and categorizes such data 148 into a format that is comprehensive and easily accessible by the patient and/or healthcare provider(s). In so doing, step 308 transforms the device-based data 148 from a vast aggregation of data 148 into actionable information relevant to the patient's CHF condition.

In at least one embodiment, the method 300 further comprises access step 310. At step 310, a user 120 accesses the platform 112 (and thus the device-based data 148 therein) by logging in via the user interface 114. In an exemplary embodiment, at step 310 the user 120 accesses the user interface 114 via a mobile application that prompts the user 120 to enter a username, password, and/or other form of identification. Once authenticated, the user 120 is provided access to those databases 145, records, and/or content for which he or she has the appropriate credentials. Furthermore, once logged into the interpretative medical data management system 100, the user 120 may communicate with other users 120 and/or vendors via the user interface 114 as previously described.

Referring back to the example of a patient user 120 who is using the interpretive medical data management system 100 in connection with CHF, by logging on to the system 100 via the user interface 114 at step 310, the user 120 can access his or her patient records and obtain near real-time, comprehensive information regarding his or her condition and biometric data 148. Where the user 120 is a healthcare provider, upon accessing the platform 112 via the user interface 114, such user 120 can call up all of their patients' records in near real-time for review, thereby allowing the healthcare provider to have the most up-to-date information immediately available. In this manner, a healthcare provider can quickly and accurately determine patient health statuses, verify patient conditions, and make timely and informed decisions regarding care.

Because some users 120 are able to access certain databases 145 and/or records but not others, as previously discussed in connection with the user interface 114 component of the system 100, in an exemplary embodiment, the various databases 145 may only be accessed via users 120 with appropriate credentials. As such, while a medical device manufacturer, researcher or payer may have the necessary credentials to access a general database comprising HIPAA compliant, de-identified information, he or she will likely not have the appropriate authorization to access patient records. Accordingly, where a user 120 is only authorized to gain access to particular databases 145, he or she accesses the system 100 as previously described at step 310 and the credentials associated with his or her username or identification restricts their access to only those database(s) 145 comprising the appropriate data 148. In this manner, non-patient and non-healthcare provider users 120 can access the aggregate data 148 received, processed and stored by the system 100 to promote research, to perform surveillance over device failures and/or for troubleshooting purposes, or for any other reason.

The method 300 may also comprise optional step 312. At step 312, the computing server 150 runs the detection application 155 to automatically alert one or more users 120 in the event a patient's device-based data 148 indicates an increased probability that a clinical event will occur. In operation, the detection application 155 continuously analyzes a patient's device-based data 148 stored on the storage server 140. If and when the detection application 155 detects data 148 trending toward or indicating a clinical event or a worsening condition (i.e. a noteworthy event), the detection application 155 provides an early warning or alert to those users 120 identified for receiving such alerts (typically the patient and his or her healthcare provider(s)). Furthermore, in at least one embodiment, the detection application 155 may also provide such individuals with a summary of the relevant diagnostic data 148 to further facilitate a fast and effective response to the interpreted device-based data 148. In this manner, the interpretive medical data management system 100 can provide early warning and early diagnosis, both of which are useful in avoiding hospitalizations, reducing readmission costs, and improving the overall quality of care.

Referring back to the explanatory example of a CHF patient utilizing the interpretive medical data management system 100 and method 300, consider the CHF patient feeling normal and located at home (or any other place remote to a hospital or care facility). At step 312, the detection application 155 is automatically and continuously analyzing the CHF patient's device-based data 148 as it is stored on the platform 112. If the CHF patient begins to accumulate fluid in his or her lungs, even in the event the fluid accumulation is at a low enough level so the patient is not yet symptomatic and does not recognize that this is occurring, the detection application 155 will detect this trend as a noteworthy event. Accordingly, the detection application 155 issues an alert regarding the noteworthy event to the CHF patient and his or her healthcare provider(s) and, optionally, may also provide the relevant device-based data 148 to such individuals. Accordingly, step 312 facilitates a fast, actionable response to the device-based data 148 interpreted by the system 100.

It will be appreciated that the steps of the method 300 may occur continuously and concurrently and the particular arrangement of elements in the flow chart of FIG. 2 is not meant to imply a fixed order to the steps. Rather, the steps of method 300 can be practiced in any order and at any time that is practicable for the various embodiments of the invention. Accordingly, device-based data 148 is continuously collected by the medical devices 110 and uploaded to the system 100 at steps 302 and 304, and the computing server 150 continuously and repeatedly runs applications 155 on such device-based data 148 to process and interpret the same at steps 306 and 308. In addition, the computing server 150 may also continuously and repeatedly run any detection applications 155 desired in order to support early warning functionality and patient attunement of their behaviors. Furthermore, users 120 may access the information stored in the platform 112 at step 310 at any time and, as described above, the system 100 is configured to support multiple users 120 accessing the platform 112 through user interface 114 concurrently.

While various embodiments of the interpretive medical data management system and methods of using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A computer aided, data-driven interpretation and management system comprising:
a platform comprising:
at least one storage server for storing data thereon, and
at least one computing server comprising at least one application capable of interacting with the data stored on the at least one storage server;
at least one device in communication with the platform, wherein the at least one device collects patient data from a patient; and
at least one user interface in communication with the platform, the at least one user interface for accessing and displaying the patient data stored on the at least one storage server;
wherein the at least one application analyzes and interprets the patient data collected from the patient from the at least one device to result in actionable diagnostic data in near real-time.

2. The system of claim 1, wherein at least one of the at least one application receives and aggregates the patient data collected from the patient from the at least one device on a continuous basis, and routes the aggregated data to the at least one storage server for storage thereon.

3. The system of claim 2, wherein the at least one application receives, aggregates and stores the patient data on a near real-time basis.

4. The system of claim 1, wherein at least one of the at least one application interprets the patient data collected from the patient from the at least one device into actionable, diagnostic information.

5. The system of claim 1, wherein at least one of the at least one application analyzes the patient data collected from the patient from the at least one device to detect a noteworthy event therein.

6. The system of claim 5, wherein a noteworthy event comprises a variation from statistical data, a data value, a data pattern or trend, or a statistical estimation.

7. The system of claim 5, wherein the at least one application applies diagnostic or predictive algorithms to detect the noteworthy event.

8.-10. (canceled)

11. The system of claim 1, wherein the at least one device comprises a pacemaker.

12. The system of claim 1, wherein the at least one device comprises an implantable cardioverter defibrillator.

13. The system of claim 1, wherein the at least one device comprises an implant for cardiac resynchronization therapy.

14. The system of claim 1, wherein the patient data comprises data selected from the group consisting of hemodynamic data, thoracic fluid content data, and heart rate variation data.

15. The system of claim 1, wherein the patient data comprises data selected from the group consisting of biometric data and physiologic data.

16. The system of claim 1, wherein the patient data comprises data selected from the group consisting of temperature data, respiratory rate data, oxygen saturation data, and weight data.

17.-21. (canceled)

22. The system of claim 1, wherein the patient data is stored within a patient information database within the at least one storage server.

23. (canceled)

24. The system of claim 22, wherein the actionable diagnostic data is stored within a second database within the at least one storage server.

25.-27. (canceled)

28. The system of claim 1, further comprising:
at least one reference database in communication with the platform.

29.-32. (canceled)

33. The system of claim 1, wherein at least one of the at least one application comprises a detection application configured to generate an alert regarding a potential clinical event.

34.-59. (canceled)

60. A method for interpreting and managing device-based data, the method comprising the steps of:
(a) establishing a communication link with at least one device collecting data from a patient;
(b) receiving data from the at least one device and routing the data to at least one storage server for storage thereon;
(c) running at least one application on a server to interpret the data into actionable, diagnostic information; and
(d) displaying the actionable, diagnostic information to a user through a user interface.

61. The method of claim 60, further comprising the step of:
(e) analyzing the actionable, diagnostic information to detect a noteworthy event therein.

62. The method of claim 61, further comprising the steps of:
(f) detecting a noteworthy event, and
(g) alerting one or more users as to the occurrence of the noteworthy event.

63.-69. (canceled)
